(19) United States
(12) Patent Application Publication
(10) Pub. No.: US 2011/0102555 A1
(43) Pub. Date: May 5, 2011

(54) Stereoscopic Image Reproduction Apparatus, Stereoscopic Image Reproduction Method and Stereoscopic Image Reproduction System

(76) Inventor: Yoshiki Yasui, Iruma-shi (JP)

(21) Appl. No.: 12/855,052

(22) Filed: Aug. 12, 2010

(30) Foreign Application Priority Data
Oct. 30, 2009 (JP) 2009-251175

(51) Int. Cl. H04N 13/04

(52) U.S. Cl. 348/51; 348/E13.036

(57) ABSTRACT

According to one embodiment, a stereoscopic image reproduction apparatus is configured to output a video signal on which signal processing corresponding to stereoscopic image display has been performed, when stereoscopic viewing glasses are being worn, and configured to perform one of outputting a video signal on which signal processing corresponding to two-dimensional image display has been performed, instead of the signal on which the signal processing corresponding to stereoscopic image display has been performed, and stopping outputting of the video signal on which the signal processing corresponding to stereoscopic image display has been performed, when stereoscopic viewing glasses are not being worn.

### CROSS-REFERENCE TO RELATED APPLICATIONS

This application is based upon and claims the benefit of priority from Japanese Patent Application No. 2009-251175, filed Oct. 30, 2009; the entire contents of which are incorporated herein by reference.

### FIELD

Embodiments described herein relate generally to a stereoscopic image reproduction device, a stereoscopic image reproduction method and a stereoscopic image reproduction system for displaying a stereoscopic image, for example, on a liquid crystal display panel or the like.

### BACKGROUND

As is well known, development of technology which allows a user to perceive a stereoscopic image by using a planar image display screen has been proceeding. This technology prepares two kinds of images mutually having parallaxes which each correspond to a space between two human eyes. Of the two kinds of images, an image for the right eye is perceived by the right eye of the user, and an image for the left eye is perceived by the left eye of the user, so that stereoscopic viewing is achieved.

Specifically, there exists technology which displays an image for the right eye and an image for the left eye in an alternate manner on the same image display screen, and controls stereoscopic viewing glasses worn by the user so that a shutter of the left eye is closed when the image for the right eye is displayed, and a shutter of the right eye is closed when the image for the left eye is closed, thereby causing a stereoscopic image to be perceived by the user.

Such technology of reproducing a stereoscopic image has reached a high level at which practical use of the technology may be possible. Accordingly, from the time forward, not only technical development for allowing the user to perceive a more realistic stereoscopic image but also development for increasing ease of handling for the user in order to promote practical use are critical issues.

Jpn. Pat. Appln. KOKAI Publication No. 2000-004453 discloses that it is determined whether or not glasses for three-dimensional image viewing are being worn. In this case, if it is determined that the glasses are being worn, then right and left three-dimensional images are alternately displayed on a monitor. Alternatively, if it is determined that the glasses are not being worn, then a two-dimensional image is displayed on the monitor.

### BRIEF DESCRIPTION OF THE DRAWINGS

FIG. 1 is a block diagram for schematically illustrating an exemplary stereoscopic image reproduction system according to an embodiment of the invention;

FIG. 2 is a block diagram for illustrating an exemplary signal processing system of a digital television broadcast receiving device included in the stereoscopic image reproduction system in the embodiment;

FIG. 3 is a block diagram for illustrating an exemplary video output module of the digital television broadcast receiving device in the embodiment;

FIGS. 4A, 4B, 4C, 4D, and 4E each illustrate exemplary specific processing operation of a stereoscopic viewing video signal in the video output module in the embodiment;

FIG. 5 is a flowchart for illustrating an example of the main processing operation which the video output module in the embodiment performs;

FIG. 6 is a flowchart for illustrating another example of the main processing operation which the video output module in the embodiment performs; and

FIG. 7 is a flowchart for illustrating still another example of the main processing operation which the video output module in the embodiment performs.

### DETAILED DESCRIPTION

In general, according to one embodiment, a stereoscopic image reproduction apparatus is configured to output a video signal on which signal processing corresponding to stereoscopic image display has been performed, when stereoscopic viewing glasses are being worn, and configured to perform one of outputting a video signal on which signal processing corresponding to two-dimensional image display has been performed, instead of the signal on which the signal processing corresponding to stereoscopic image display has been performed, and stopping outputting of the video signal on which the signal processing corresponding to stereoscopic image display has been performed, when stereoscopic viewing glasses are not being worn.

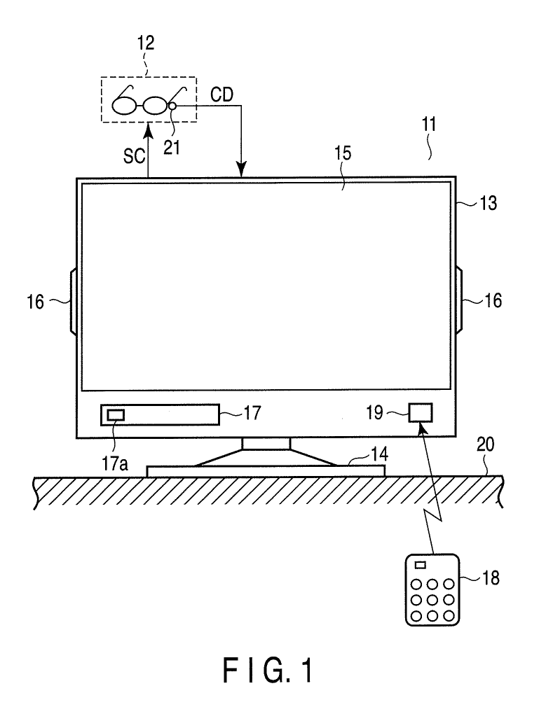

FIG. 1 schematically illustrates a stereoscopic image reproduction system to be described in this embodiment. The stereoscopic image reproduction system comprises a digital television broadcast receiving device 11 as a stereoscopic image reproduction device, and stereoscopic viewing glasses 12 to perceive a stereoscopic image from a displayed image of the digital television broadcast receiving device 11.

Of these elements, the digital television broadcast receiving device 11 is made up of a thin cabinet 13 and a support table 14 which supports the cabinet 13. A liquid crystal display panel 15 as an image display module is disposed at the center on the front of the cabinet 13. Speakers 16, 16 are disposed on both sides of the cabinet 13 and are configured to allow stereo audio reproduction to be performed.

An operating module 17 comprising a main power source switch 17a, and a light receiver 19 to receive operation data transmitted from a remote controller 18 are further disposed in a lower part on the front of the cabinet 13. The support table 14 is rotatably connected to the center of the bottom surface of the cabinet 13, and is configured to support the cabinet 13 upright in a state in which the support table 14 is mounted on the horizontal surface of a given base 20.

Here, when receiving a video signal to be broadcast for stereoscopic viewing, the digital television broadcast receiving device 11 separately generates a video signal for the right eye and a video signal for the left eye based on the received video signal and displays an image for the right eye and an image for the left eye in an alternate manner on the liquid crystal display panel 15.

The digital television broadcast receiving device 11 also generates a shutter control signal SC alternately indicating a period during which an image for the right eye is displayed and a period during which an image for the left eye is displayed, and outputs the shutter control signal SC to the stereoscopic viewing glasses 12.

Based on the shutter control signal SC supplied from the digital television broadcast receiving device 11, the stereoscopic viewing glasses 12 are controlled to close a shutter of the left eye when an image for the right eye is displayed and to close a shutter of the right eye when an image for the left eye is displayed. This allows the user to perceive a stereoscopic image.

The stereoscopic viewing glasses 12 comprise a removal detector 21 to detect whether the user is wearing the glasses, that is, whether the user is wearing the glasses or has removed them. A removal detection signal CD output from the removal detector 21 is supplied to the digital television broadcast receiving device 11.

When the removal detection signal CD indicating that the user is wearing the stereoscopic viewing glasses 12 is supplied, the digital television broadcast receiving device 11 performs stereoscopic image display by displaying an image for the right eye and an image for the left eye in an alternate manner on the liquid crystal display panel 15.

When the removal detection signal CD indicating that the user is not wearing the stereoscopic viewing glasses 12 is supplied, the digital television broadcast receiving device 11 operates to convert a received stereoscopic viewing video signal into a normal, two-dimensional display video signal, and to cause the two-dimensional display video signal to be displayed as an image on the liquid crystal display panel 15.

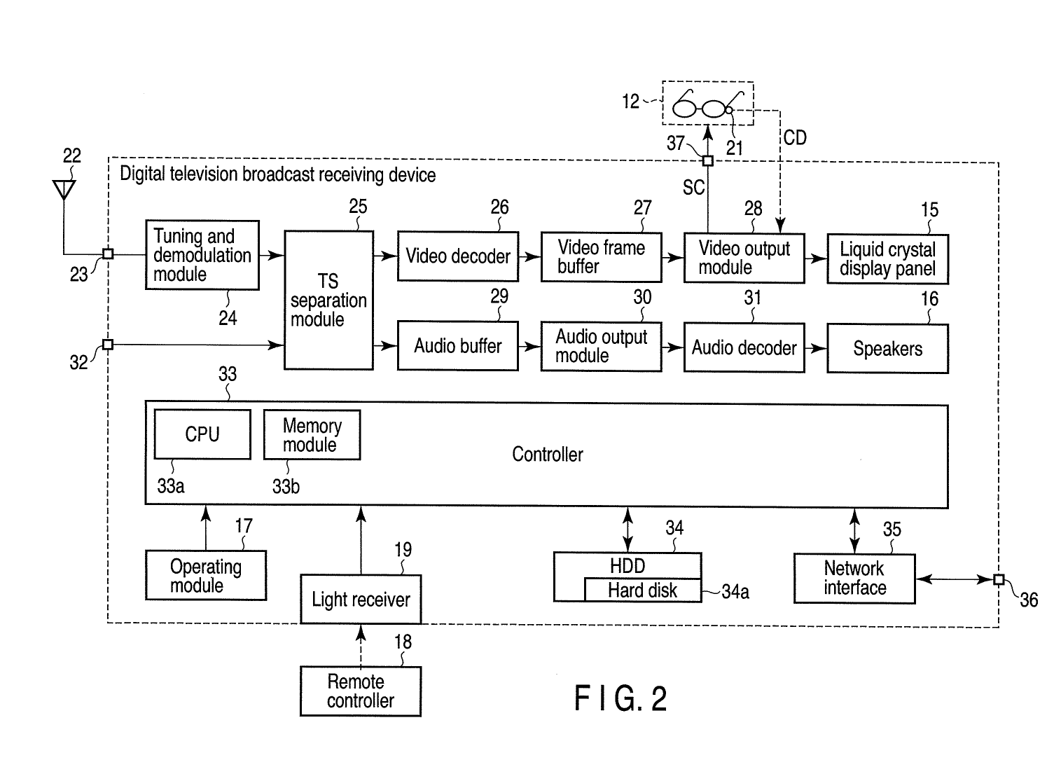

FIG. 2 schematically illustrates a signal processing system of the digital television broadcast receiving device 11. That is, digital television broadcast signals received by an antenna 22 are supplied through an input terminal 23 to a tuning and demodulation module 24. The tuning and demodulation module 24 selects a signal of a desired channel from the input digital television broadcast signals and performs demodulation processing on the selected broadcast signal to generate a transport stream (TS).

The TS output from the tuning and demodulation module 24 is supplied to a TS separation module 25, and is separated into a video component and an audio component. Of these components, the video component is subjected to decode processing by a video decoder 26 to be restored to the original digital video signal, and then is stored in a video frame buffer 27. The video signal stored in the video frame buffer 27 is read on a frame-by-frame basis into a video output module 28 and is subjected to a given signal processing to be described later, and then is supplied to the liquid crystal display panel 15 so as to be used for image display.

The audio component separated in the TS separation module 25 is once stored in an audio buffer 29, and then is read by an audio output module 30 and is subjected to a given signal processing. The audio component output from the audio output module 30 is subjected to decode processing by an audio decoder 31 to be restored to the original digital audio data, and then is converted into analog data so as to be used for sound reproduction by the speakers 16.

Note that the digital television broadcast receiving device 11 comprises an input terminal 32. Supplied to the input terminal 32 is a TS output from an external recording and reproduction device, such as an optical disk recording and reproduction device which performs recoding and reproduction for an optical disk, such as a digital versatile disk (DVD), or an external hard disk drive (HDD). The TS input to the input terminal 32 is supplied to the TS separation module 25. The TS separation module 25 operates to select one of the TS supplied from the tuning and demodulation module 24 and the TS supplied from the input terminal 32 and separate the selected TS into a video component and an audio component.

Here, in the digital television broadcast receiving device 11, various operations including various kinds of receiving operation mentioned above are centrally controlled by a controller 33. A central processing unit (CPU) 33a is built in the controller 33, and the controller 33 receives operation data from the operating module 17 or operation data which is transmitted from the remote controller 18 and received by the light receiver 19, and controls each module such that the nature of operation of the data is reflected.

In this case, the controller 33 utilizes a memory module 33b. The memory module 33b mainly comprises a read-only memory (ROM) storing a control program to be executed by the CPU 33a, a random access memory (RAM) for providing a working area to the CPU 33a, and a nonvolatile memory in which various kinds of setting data and control data are stored.

The controller 33 is connected to an integrated HDD 34. Based on the user's operation, the controller 33 encrypts digital video and audio signals and the like obtained from the video decoder 26 and the audio decoder 31 and converts the signals into a given recording format, and then supplies the signals to the HDD 34, thereby enabling the signals to be recorded on a hard disk 34a.

Based on the user's operation, the controller 33 also causes the HDD 34 to read desired video and audio signals and the like from the hard disk 34a and decrypts the signals, and then supplies the signals to the video frame buffer 27 and the audio decoder 31, thereby enabling the signals to be used for image display and sound reproduction.

Further, the controller 33 is connected through a network interface 35 and an input and output terminal 36 to a network, such as the Internet. This enables the controller 33 to access a server on the network based on the user's operation so as to acquire desired video and audio signals and the like, so that the signals are used for image display and sound reproduction and are recorded on the hard disk 34a by the HDD 34.

Here, in cases where a video signal supplied on a frame-by-frame basis from the video frame buffer 27 is a normal, two-dimensional display video signal, the video output module 28 performs frame rate-doubling conversion processing on the video signal so as to enable the video signal to be displayed on the liquid crystal display panel 15, and then supplies the video signal to the liquid crystal display panel 15, so that the video signal is displayed as an image.

In cases where the video signal supplied on the frame-by-frame basis from the video frame buffer 27 is a stereoscopic viewing video signal, the video output module 28 separately generates a video signal for the right eye and a video signal for the left eye from the video signal, and outputs the video signals in an alternate manner to the liquid crystal display panel 15 so as to be used for image display.

At this point, the video output module 28 generates the shutter control signal SC alternately indicating a period during which an image for the right eye is displayed and a period during which an image for the left eye is displayed, and outputs the shutter control signal SC through an output terminal 37 to the stereoscopic viewing glasses 12.

Accordingly, based upon the shutter control signal SC supplied from the digital television broadcast receiving device 11, the stereoscopic viewing glasses 12 are controlled to close the shutter of the left eye when an image for the right eye is displayed and to close the shutter of the right eye when an image for the left eye is displayed. This allows the user to perceive a stereoscopic image.

Note that, for example, when the controller 33 detects attribute data attached to a video signal to be used for image display, it can easily be determined whether a video signal supplied on a frame-by-frame basis from the video frame buffer 27 is a normal, two-dimensional display video signal or a stereoscopic viewing video signal.

The stereoscopic viewing glasses 12 comprise the removal detector 21 to detect whether the user is wearing the glasses, as mentioned above. As the removal detector 21, detectors using various methods are conceivable. For example, one method is that, depending on the presence of pressure, it is detected whether or not the user is wearing glasses. Another method is that, depending on whether or not an emitted infrared ray is reflected from the surface of the liquid crystal display panel 15 and is received, it is detected whether or not the user is wearing glasses. Another method is that, depending on inclination, it is detected whether or not the user is wearing glasses.

The removal detector 21 transmits the removal detection signal CD wirelessly, and the transmitted removal detection signal CD is received by the video output module 28. When a video signal is a stereoscopic viewing video signal supplied from the video frame buffer 27 and the removal detection signal CD indicating that the user is wearing the stereoscopic viewing glasses 12 is supplied, the video output module 28 separately generates a video signal for the right eye and a video signal for the left eye from the video signal, and performs stereoscopic image display by displaying the video signals as images in an alternate manner on the liquid crystal display panel 15.

When the removal detection signal CD indicating that the user is not wearing the stereoscopic viewing glasses 12 is supplied, the video output module 28 converts the received stereoscopic viewing video signal into a normal, two-dimensional display video signal and performs frame rate-doubling conversion processing on the two-dimensional display video signal so as to enable the video signal to be displayed on the liquid crystal display panel 15, and then supplies the video signal to the liquid crystal display panel 15, so that the video signal is displayed as an image.

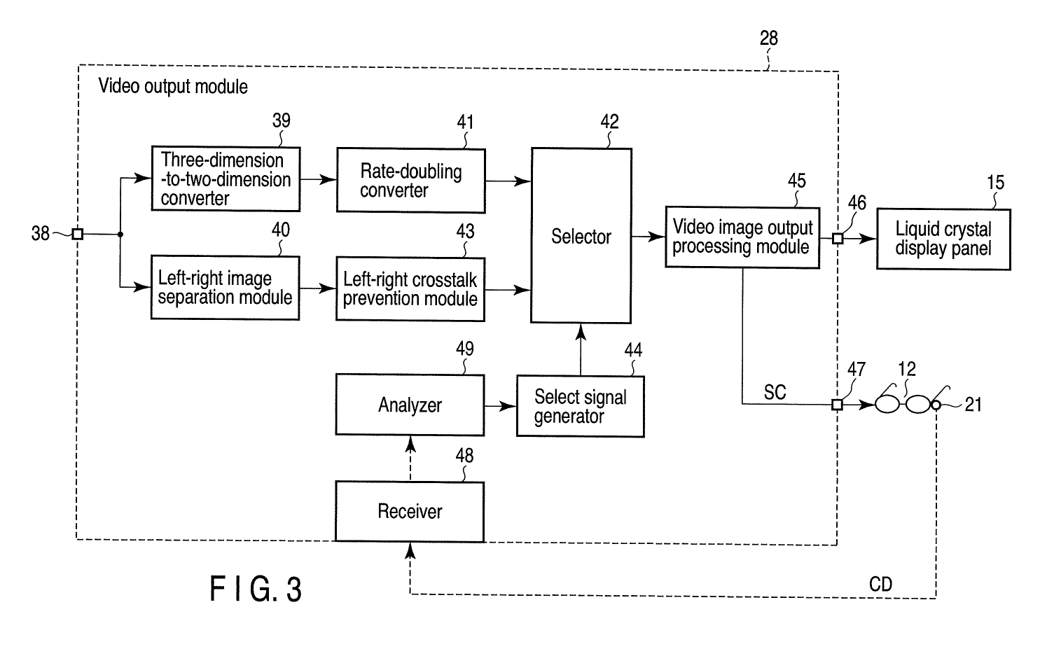

FIG. 3 illustrates an example of the video output module 28. That is, the video signal supplied from the video frame buffer 27 is supplied through an input terminal 38 both to a three-dimension-to-two-dimension converter 39 and a left-right image separation module 40.

When a normal, two-dimensional display video signal is input, the three-dimension-to-two-dimension converter 39, of these components, outputs the video signal in its original state to a rate-doubling converter 41 at the subsequent stage. When a stereoscopic viewing video signal is input, the three-dimension-to-two-dimension converter 39 converts the video signal into a two-dimensional display video signal and outputs the two-dimensional display video signal to the rate-doubling converter 41. Using, for example, a method of creating an interpolated frame utilizing a motion vector between frames, the rate-doubling converter 41 performs frame rate-doubling conversion processing on the input two-dimensional display video signal, which enables the video signal to be displayed as an image on the liquid crystal display panel 15, and outputs the video signal to one input terminal of a selector 42.

When a stereoscopic viewing video signal is input, the right and left image separation module 40 separates the video signal into a video signal for the right eye and a video signal for the left eye, and outputs the video signals at a doubled rate in an alternate manner to a left-right crosstalk prevention module 43. The left-right crosstalk prevention module 43 inserts a black video signal between the video signal for the right eye and the video signal for the left eye, which are alternately input, to perform processing for preventing crosstalk upon switching between an image for the right eye and an image for the left eye, and then outputs the video signals to the other input terminal of the selector 42.

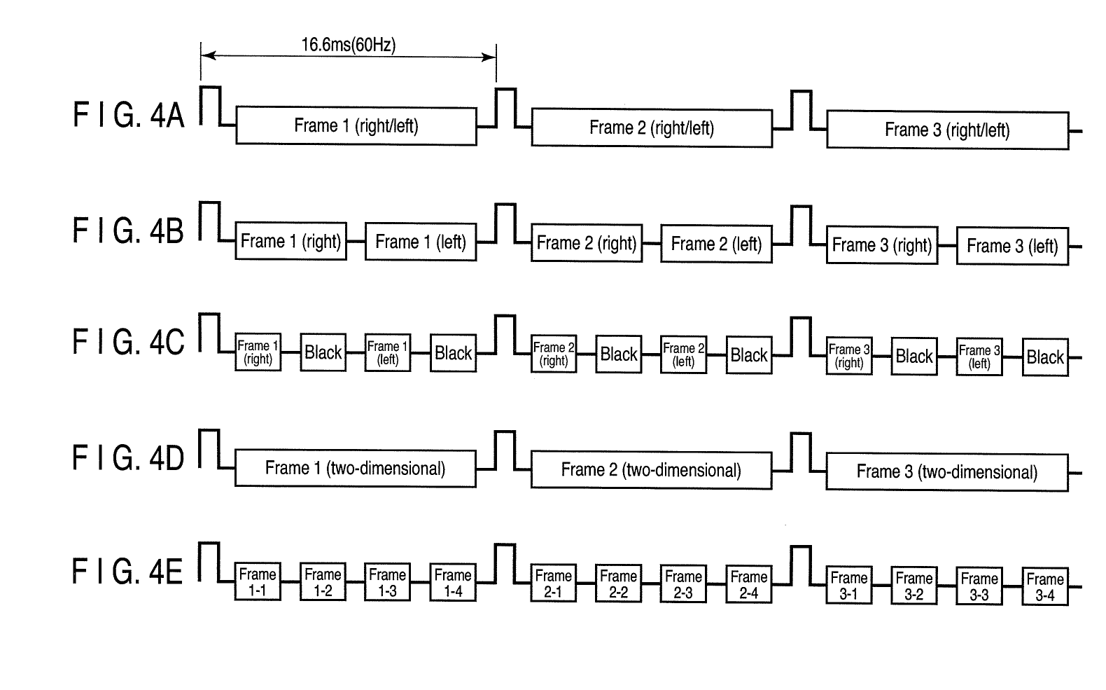

Specifically speaking, suppose that a stereoscopic viewing video signal (right/left) in which a video signal for the right eye (right) and a video signal for the left eye (left) are combined, as illustrated in FIG. 4A, is supplied at a frame frequency of 60 Hz to the input terminal 38.

Then, as illustrated in FIG. 4B, the right and left image separation module 40 separates the input stereoscopic viewing video signal (right/left) into a video signal for the right eye (right) and a video signal for the left eye (left), and outputs the video signals at a frame frequency (120 Hz in this case) obtained by doubling the previous frequency (60 Hz) to the left-right crosstalk prevention module 43. As illustrated in FIG. 4C, the left-right crosstalk prevention module 43 inserts a black video signal between the input video signal for the right eye (right) and the video signal for the left eye (left), and outputs the video signals at a frame frequency (240 Hz in this case) obtained by further doubling the previous frequency (120 Hz) to the other input terminal of the selector 42.

On the other hand, the three-dimension-to-two-dimension converter 39 converts the stereoscopic viewing video signal (right/left) illustrated in FIG. 4A into a two-dimensional display video signal having the same frame frequency (60 Hz in this case) as the stereoscopic viewing video signal (right/left), as illustrated in FIG. 4D, and outputs the two-dimensional display video signal to the rate-doubling converter 41. Then, the rate-doubling converter 41 performs processing using frame interpolation and the like on the input two-dimensional display video signal such that the resultant frame frequency is four times (i.e., 240 Hz) that of the input two-dimensional display video signal, as illustrated in FIG. 4E, and outputs the resultant video signal to one input terminal of the selector 42.

Then, the selector 42 selects a video signal from video signals supplied from both the rate-doubling converter 41 and the left-right crosstalk prevention module 43, based on a select signal output from a select signal generator 44 to be described later, and outputs the selected video signal to a video image output processing module 45. The video image output processing module 45 performs a given signal processing on the input video signal for enabling the video signal to be used for image display on the liquid crystal display panel 15, and outputs the video signal through an output terminal 46 to the liquid crystal display panel 15.

Further, in cases where the input video signal is a stereoscopic viewing video signal, the video image output processing module 45 generates the shutter control signal SC alternately indicating a period during which an image for the right eye is displayed and a period during which an image for the left eye is displayed, and outputs the shutter control signal SC through an output terminal 47 to the stereoscopic viewing glasses 12.

Accordingly, based upon the shutter control signal SC supplied from the video image output processing module 45, the stereoscopic viewing glasses 12 are controlled to close the shutter of the left eye when an image for the right eye is displayed and to close the shutter of the right eye when an image for the left eye is displayed. This allows the user to perceive a stereoscopic image.

The removal detection signal CD output wirelessly from the removal detector 21 included in the stereoscopic viewing glasses 12 is received by a receiver 48 in the video output module 28. The removal detection signal CD received by the receiver 48 is supplied to an analyzer 49, and it is determined whether the user is wearing the stereoscopic viewing glasses 12.

Then, if the analyzer 49 determines that the user is wearing the stereoscopic viewing glasses 12, the analyzer 49 causes the select signal generator 44 to generate a select signal which switches the selector 42 to lead a video signal output from the left-right crosstalk prevention module 43 to the video image output processing module 45. If the analyzer 49 determines that the user is not wearing the stereoscopic viewing glasses 12, the analyzer 49 causes the select signal generator 44 to generate a select signal which switches the selector 42 to lead a video signal output from the rate-doubling converter 41 to the video image output processing module 45.

With the above-mentioned video output module 28, when the user removes the stereoscopic viewing glasses 12 with a stereoscopic viewing video signal being used for image display on the liquid crystal display panel 15, a two-dimensional display video signal converted from a stereoscopic viewing video signal is automatically used for image display on the liquid crystal display panel 15. Alternatively, when the user is wearing the stereoscopic viewing glasses 12, a stereoscopic viewing video signal is automatically used for image display on the liquid crystal display panel 15, allowing the user to perceive a stereoscopic image.

In other words, when the user is wearing the stereoscopic viewing glasses 12, image display using a stereoscopic viewing video signal is performed, whereas when the user is not wearing the stereoscopic viewing glasses 12, switching is automatically performed to perform image display using a two-dimensional display video signal. Therefore, the user's handling can be made easier, making the technology preferable for practical use.

In cases where a stereoscopic viewing video signal is used for image display on the liquid crystal display panel 15, signal processing specialized for a stereoscopic viewing video signal is performed, in which a black video signal is inserted between a video signal for the right eye and a video signal for the left eye separated from a stereoscopic viewing video signal to prevent crosstalk upon switching between an image for the right eye and an image for the left eye. This is intended to improve quality of an image displayed for stereoscopic viewing.

Also, in cases where a two-dimensional display video signal obtained by conversion is used for image display on the liquid crystal display panel 15, frame rate-doubling conversion processing is performed on the two-dimensional display video signal so as to enable the two-dimensional display video signal to be displayed on the liquid crystal display panel 15. This enables the liquid crystal display panel 15 to perform well, improving the quality of a displayed image of a two-dimensional display video signal.

In other words, both in cases where image display using a stereoscopic viewing video signal is performed and in cases where image display using a two-dimensional display video signal is performed, consideration is given so as not to decrease the quality of a displayed image. This also contributes well to promoting practical use of the technology.

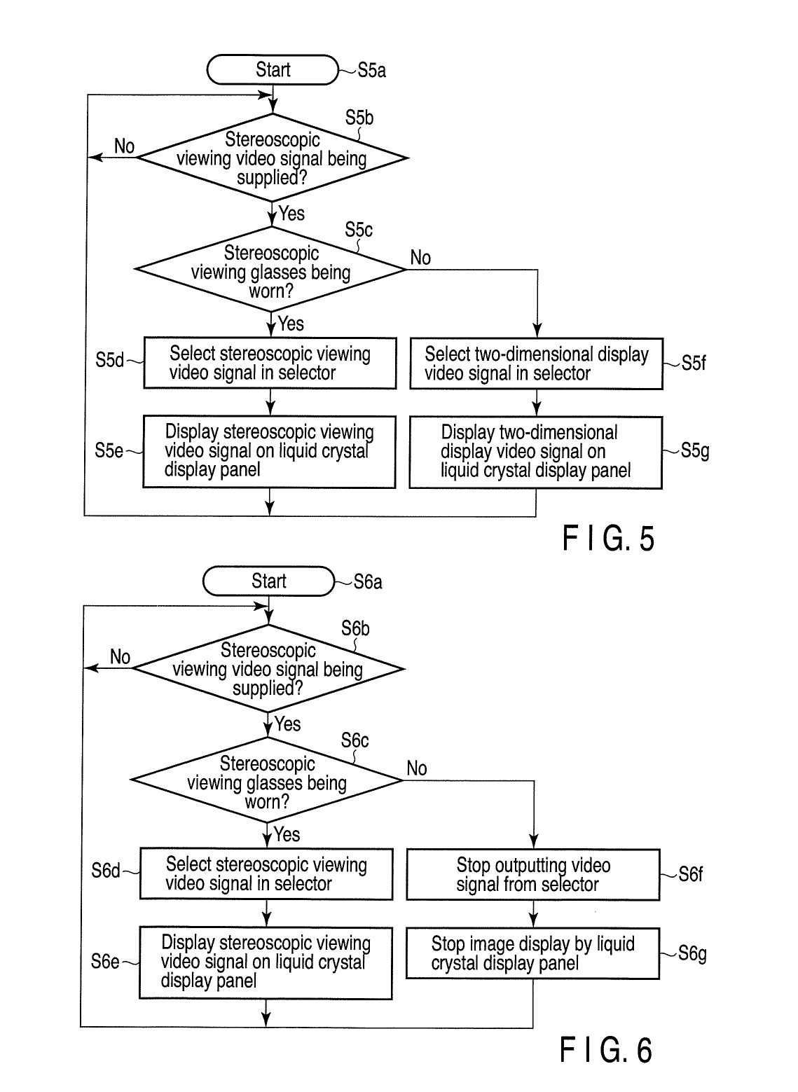

FIG. 5 is a flowchart of the main processing operation of the video output module 28. That is, as the process starts (step S5a), the video output module 28 acquires from the controller 33 a determination result indicating whether or not a video signal supplied from the video frame buffer 27 is a stereoscopic viewing video signal, in step S5b. If it is determined that the video signal is a stereoscopic viewing video signal (YES), then it is determined in step S5c whether or not the user is wearing the stereoscopic viewing glasses 12.

If it is determined that the user is wearing the stereoscopic viewing glasses 12 (YES), then, in step S5d, the video output module 28 switches the selector 42 so that a video signal output from the left-right crosstalk prevention module 43 is supplied to the video image output processing module 45, and, in step S5e, thereby causes the stereoscopic viewing video signal on which processing of preventing crosstalk has been performed to be used for image display on the liquid crystal display panel 15. Then, the video output module 28 returns to the process in step S5b.

Alternatively, in step S5c, if it is determined that the user is not wearing the stereoscopic viewing glasses 12 (NO), then, in step S5f, the video output module 28 switches the selector 42 so that a video signal output from the rate-doubling converter 41 is supplied to the video image output processing module 45, and, in step S5g, thereby causes the two-dimensional display video signal on which frequency-doubling conversion processing has been performed to be used for image display on the liquid crystal display panel 15. Then, the video output module 28 returns to the process in step S5b.

Note that, in the above description on the video output module 28, crosstalk prevention processing has been exemplified in which, for a stereoscopic viewing video signal, a black video signal is inserted between a video signal for the right eye and a video signal for the left eye. However, signal processing performed on a stereoscopic viewing video signal is not limited to the crosstalk prevention processing. For a stereoscopic viewing video signal, various processing which can improve the quality of the displayed image, such as processing of controlling the brightness of a backlight of the liquid crystal display panel 15 for every display area to enhance the effect of stereoscopic viewing display, may be applied.

In the video output module 28, a video signal output from the rate-doubling converter 41 or a video signal output from the left-right crosstalk prevention module 43 is selected by the selector 42 depending on whether the user is wearing the stereoscopic viewing glasses 12 or has removed them. In addition to the selection, for example, the operations of the three-dimension-to-two-dimension converter 39 and the rate-doubling converter 41 are stopped when the user is wearing the stereoscopic viewing glasses 12 whereas the operations of the right and left image separation module 40 and the left-right crosstalk prevention module 43 are stopped when the user is not wearing the stereoscopic viewing glasses 12. As a result, useless processing is reduced or eliminated to allow electric power saving to be promoted.

FIG. 6 is a flowchart of another example of the main processing operation of the video output module 28. That is, as the process starts (step S6a), the video output module 28 acquires from the controller 33 a determination result indicating whether or not a video signal supplied from the video frame buffer 27 is a stereoscopic viewing video signal, in step S6b. If it is determined that the video signal is a stereoscopic viewing video signal (YES), then it is determined in step S6c whether or not the user is wearing the stereoscopic viewing glasses 12.

If it is determined that the user is wearing the stereoscopic viewing glasses 12 (YES), then, in step S6d, the video output module 28 switches the selector 42 so that a video signal output from the left-right crosstalk prevention module 43 is supplied to the video image output processing module 45, and, in step S6e, thereby causes the stereoscopic viewing video signal on which processing of preventing crosstalk has been performed to be used for image display on the liquid crystal display panel 15. Then, the video output module 28 returns to the process in step S6b.

Alternatively, in step S6c, if it is determined that the user is not wearing the stereoscopic viewing glasses 12 (NO), then, in step S6f, the video output module 28 stops outputting a video signal from the selector 42 to prevent the video signal from being supplied to the liquid crystal display panel 15, and, in step S6g, thereby stops image display by the liquid crystal display panel 15. Then, the video output module 28 returns to the process in step S6b.

The processing operation illustrated in FIG. 6 differs from that illustrated in FIG. 5 in that, if the user is not wearing the stereoscopic viewing glasses 12, displaying an image on the liquid crystal display panel 15 is stopped instead of displaying an image for two-dimensional display. With such processing operation, stereoscopic image display is stopped if the user removes the stereoscopic viewing glasses 12, and the stereoscopic image display is resumed if the user puts the stereoscopic viewing glasses 12 back on again. This can make user's operations very convenient.

Note that whether an image for two-dimensional display is to be displayed or image display is to be stopped when the user is not wearing the stereoscopic viewing glasses 12 may be set by user's operations.

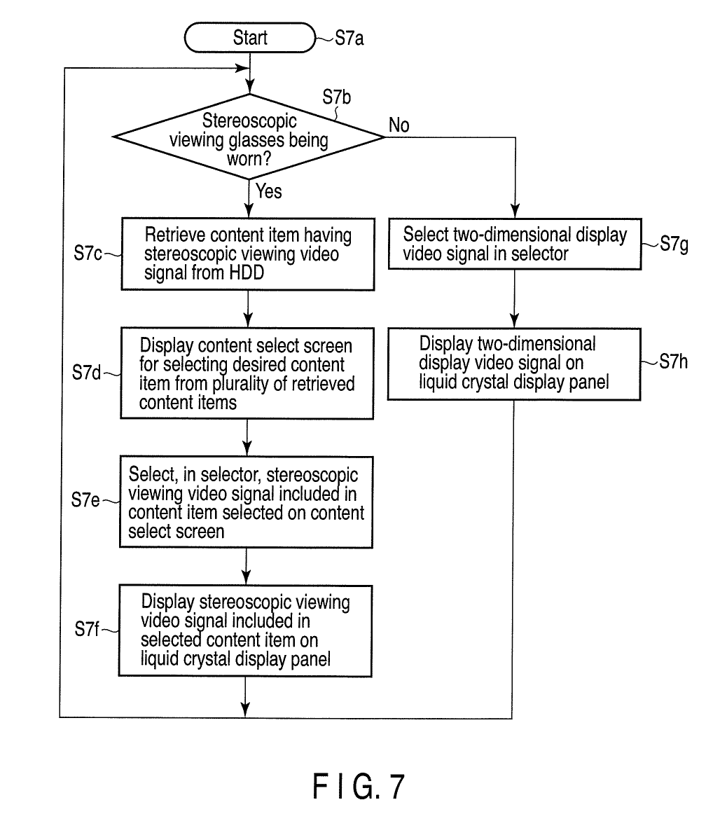

FIG. 7 is a flowchart of still another example of the main processing operation of the video output module 28. That is, as the process starts (step S7a), the video output module 28 determines in step S7b whether or not the user is wearing the stereoscopic viewing glasses 12. If it is determined that the user is wearing the stereoscopic viewing glasses 12 (YES), then, in step S7c, the video output module 28 retrieves a content item having a reproducible stereoscopic viewing video signal from various kinds of content items recorded on the hard disk 34a of the integrated HDD 34.

Then, in step S7d, the video output module 28 displays a content select screen for allowing the user to select a desired content item from a plurality of retrieved content items on the liquid crystal display panel 15. Upon recognizing that the user selects a desired content item from the content select screen, in step S7e, the video output module 28 switches the selector 42 so that a video signal output from the left-right crosstalk prevention module 43 is supplied to the video image output processing module 45, and, in step S7f, thereby causes the stereoscopic viewing video signal included in the content item selected on the content select screen to be used for image display on the liquid crystal display panel 15. Then, the video output module 28 returns to the process in step S7b.

Alternatively, in step S7b, if it is determined that the user is not wearing the stereoscopic viewing glasses 12 (NO), then, in step S7g, the video output module 28 switches the selector 42 so that a video signal output from the rate-doubling converter 41 is supplied to the video image output processing module 45, and, in step S7h, thereby causes the two-dimensional display video signal on which frequency-doubling conversion processing has been performed to be used for image display on the liquid crystal display panel 15. Then, the video output module 28 returns to the process in step S7b.

With the processing operation illustrated in FIG. 7, if the user is wearing the stereoscopic viewing glasses 12, the user is automatically allowed to select a content item including a stereoscopic viewing video signal recorded on the HDD 34. Therefore, the user has only to select the content item. This can make user's operations very convenient.

The processing operation illustrated in FIG. 7 may be set such that, when the user is wearing the stereoscopic viewing glasses 12, a specific content item is automatically selected among content items including stereoscopic viewing video signals recorded on the HDD 34. The processing operation may also be set such that, when the user is wearing the stereoscopic viewing glasses 12, it is possible to retrieve a content item including a stereoscopic viewing video signal not only from the HDD 34 but also from a server on a network.

While, in the foregoing embodiment, a description has been given of image display by using the liquid crystal display panel 15, it will be understood that the embodiment is not limited thereto, and, for example, a plasma display panel and a cathode ray tube (CRT) display which allow for image display for stereoscopic viewing may be used.

Moreover, in the foregoing embodiment, the digital television broadcast receiving device 11 is exemplified as a stereoscopic image reproduction device. However, the embodiment is not limited thereto. This embodiment is applicable to devices capable of reproducing video signals, such as an optical disk recording and reproduction device, a personal computer (PC) and a set top box (STB).

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A stereoscopic image reproduction apparatus comprising:
a first processing module configured to perform signal processing corresponding to stereoscopic image display on an input stereoscopic viewing video signal;
a second processing module configured to convert the input stereoscopic viewing video signal into a two-dimensional display video signal and perform signal processing corresponding to two-dimensional image display on the two-dimensional display video signal; and
a controller configured to, when receiving a detection signal indicating that stereoscopic viewing glasses are being worn, output the video signal on which the signal processing has been performed in the first processing module, and configured to, when receiving a detection signal indicating that the stereoscopic viewing glasses are not being worn, perform one of outputting the video signal on which the signal processing has been performed in the second processing module, instead of the video signal on which the signal processing has been performed in the first processing module, and stopping outputting the video signal on which the signal processing has been performed in the first processing module.

2. The stereoscopic image reproduction apparatus of claim 1, wherein the controller is configured to, when receiving a detection signal indicating that the stereoscopic viewing glasses are being worn, retrieve a given content item from a plurality of content items which are recorded in advance, input a stereoscopic viewing video signal included in the retrieved content item to the first processing module, and output a video signal on which signal processing has been performed.

3. The stereoscopic image reproduction apparatus of claim 2, wherein the controller is configured to retrieve the given content item through a network.

4. The stereoscopic image reproduction apparatus of claim 1, wherein the first processing module is configured to generate, from the input stereoscopic viewing video signal, a first video signal and a second video signal which mutually have parallaxes, and insert a black video signal between the first video signal and the second video signal.

5. The stereoscopic image reproduction apparatus of claim 1, wherein the second processing module is configured to convert the input stereoscopic viewing video signal into a two-dimensional display video signal, and perform rate-doubling conversion processing on the two-dimensional display video signal.

6. A stereoscopic image reproduction method comprising:
performing signal processing corresponding to stereoscopic image display on an input stereoscopic viewing video signal;
converting the input stereoscopic viewing video signal into a two-dimensional display video signal and performing signal processing corresponding to two-dimensional image display on the two-dimensional display video signal;
when receiving a detection signal indicating that stereoscopic viewing glasses are being worn, outputting the video signal on which the signal processing corresponding to stereoscopic image display has been performed; and
when receiving a detection signal indicating that the stereoscopic viewing glasses are not being worn, performing one of outputting the video signal on which the signal processing corresponding to two-dimensional image display has been performed, instead of the video signal on which the signal processing corresponding to stereoscopic image display has been performed, and stopping outputting the video signal on which the signal processing corresponding to stereoscopic image display has been performed.

7. The stereoscopic image reproduction method of claim 6, further comprising:
when receiving the detection signal indicating that the stereoscopic viewing glasses are being worn, retrieving a given content item from a plurality of content items recorded in advance; and
performing the signal processing corresponding to stereoscopic image display on a stereoscopic viewing video signal included in the retrieved content item and outputting the stereoscopic viewing video signal.

8. A stereoscopic image reproduction system comprising:
stereoscopic viewing glasses configured to comprise a removal detector to detect whether the stereoscopic viewing glasses are being worn; and
a stereoscopic image reproduction apparatus configured to comprise:
a first processing module which performs signal processing corresponding to stereoscopic image display on an input stereoscopic viewing video signal;
a second processing module which converts the input stereoscopic viewing video signal into a two-dimensional display video signal and performs signal processing corresponding to two-dimensional image display on the two-dimensional display video signal; and
a controller which, when receiving from the removal detector a detection signal indicating that the stereoscopic viewing glasses are being worn, outputs the video signal on which the signal processing has been performed in the first processing module, and which, when receiving a detection signal indicating that the stereoscopic viewing glasses are not being worn, performs one of outputting the video signal on which the signal processing has been performed in the second processing module, instead of the video signal on which the signal processing has been performed in the first processing module, and stopping outputting the video signal on which the signal processing has been performed in the first processing module.
